(19) United States
(12) Patent Application Publication
(10) Pub. No.: US 2008/0037411 A1
(43) Pub. Date: Feb. 14, 2008

(54) Variable filtering for radio evolution

(75) Inventors: Kari Niemela, Oulu (FI); Olli Piirainen, Oulu (FI); Mikko Saily, Sipoo (FI); Jari Hulkkonen, Oulu (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/897,025

(22) Filed: Aug. 27, 2007

Related U.S. Application Data
(60) Provisional application No. 60/841,650, filed on Aug. 30, 2006.

(30) Foreign Application Priority Data
May 14, 2004 (FI) PCT/FI04/50066

(51) Int. Cl. H04J 3/06

(52) U.S. Cl. 370/208

(57) ABSTRACT

The specification and drawings present a new method, system, apparatus and software product for variable filtering of a mobile station (MS) for supporting uplink communications using available capabilities of a network element in wireless communication systems (e.g., evolved GERAN). The MS may have at least two different pulse shaping filter capabilities providing at least two different bandwidths: one narrower being suitable for legacy transceivers and another wider and thus optimal for variable symbol rate from performance point of view. A BSS (base station subsystem) may then request to use one of those filter capabilities according to BSS available resources

### PRIORITY AND CROSS-REFERENCE TO RELATED APPLICATION

This application claims priority from U.S. Patent Application Ser. No. 60/841,650, filed on Aug. 30, 2006.

### TECHNICAL FIELD

This invention generally relates to wireless communications and more specifically to variable filtering for uplink communications.

### BACKGROUND ART

EDGE (enhanced data rates for global evolution) further evolution candidates have been presented in GERAN (GSM (global system for mobile communications)/EDGE radio access network) 3GPP (3d generation partnership project). Dual Symbol Rate (DSR) for uplink performance improvement is recently proposed. This will imply using higher symbol rates in the uplink (from a mobile station to a network element).

In EDGE Evolution concept development the Dual Symbol Rate (DSR) and Modified Dual Symbol Rate (MDSR) concept have been proposed for the uplink evolution. DSR doubles the modulation rate in the transmitter of the mobile station and MDSR combines higher symbol rate (3/2) with a quadrature amplitude modulation (QAM), e.g., 16-QAM with 16 states and optionally with a quadrature phase-shift keying (QPSK, or π/4-QPSK) modulation. There are also other proposals for different symbol rates, but the principle or variable symbol rate will apply to any combination of different symbol rates and modulation orders.

In GERAN, the symbol duration for GMSK (Gaussian minimum shift keying) and 8 PSK (PSK is phase-shift keying) modulation is 3.69 μs, thus yielding approximately 270 kHz signal bandwidth with 200 kHz carrier spacing. For EDGE evolution candidates, for example, DSR yields symbol duration and signal bandwidth 1.85 μs/540 kHz and MDSR yields 2.46 μs/406 kHz respectively.

For optimized receiver performance, the receiver processes with a full sample rate (or multiple rates with over-sampling), and therefore the receiver operates with this frequency bandwidth. From the receiver point of view, this implies that, with the current 200 kHz channel spacing, the adjacent channel overlap with the receiver bandwidth inspite of the transmitter pulse shaping characteristics. Due to overlapping frequency bands, the receiver performance can be improved by applying a noise whitening filter. An optimal receiver utilizes whitening matched filter, whose effective bandwidth is equal to the symbol rate.

Transmitter filtering reduces interference because it reduces the tendency of a transmitter to interfere with another transmitter in a frequency domain. On the receiver end, filtering improves sensitivity because more noise and interference are rejected. If there are overlapping carriers due to a variable symbol rate, it would be better to separate those carriers in the receiver, and allow a full signal transmitter bandwidth in the mobile (e.g. according to the technology outline description). However, legacy base station subsystems (BSSs) may have different receiver structures and capabilities, e.g., sampling rate and width of the channel filters, which are not able to support optimal pulse shaping from the transmitter with higher symbol rate.

### DISCLOSURE OF THE INVENTION

According to a first aspect of the invention, a method, comprises: receiving by a mobile station from a network element a shaping filter switch signal comprising characteristics of a transmitter filter needed to support an uplink signal for receiving the uplink signal by the network element from the mobile station; providing the transmitter filter with the characteristics by the mobile station in response to the shaping filter switch signal.

According further to the first aspect of the invention, the providing the transmitter filter comprises: generating a filter instruction signal by the mobile station using the characteristics; and providing the filter instruction signal to a filter module for providing the transmitter filter.

According further to the first aspect of the invention, the transmitter filter may be a finite-impulse-response digital filter and the filter instruction signal may comprise finite-impulse-response filter taps for the finite-impulse-response digital filter and the finite-impulse-response filter taps may provide the characteristics of the transmitter filter.

Still further according to the first aspect of the invention, the filter module may comprise a plurality of filters and the filter instruction signal may be a switching command for switching a forming uplink signal to one filter of the plurality of the filters such that the forming uplink signal is passed through the one filter without being substantially attenuated but is substantially attenuated by all other filters of the plurality of filters, wherein the one filter is the transmitter filter with the characteristics. Further, the plurality may be equal to two.

According further to the first aspect of the invention, the transmitter filter may be a digital interpolation filter and the filter instruction signal may be a cutoff frequency of the digital interpolation filter.

According still further to the first aspect of the invention, the shaping filter switch signal may be a digital bit which value indicates one of two predetermined sets of the characteristics for the transmitter filter.

According further still to the first aspect of the invention, the transmitter filter may be a digital filter.

Still further still according to the first aspect of the invention, the uplink signal may have a dual symbol rate of 13/24 MHz with the bandwidth at half power substantially equals 541 kHz, the uplink signal may have a modified dual symbol rate of 13/32 MHz with the bandwidth at half power substantially equals 405 kHz, or the uplink signal may have a rate of 13/48 or 13/40 MHz with the bandwidth at half power substantially equals 325 kHz.

According to a second aspect of the invention, a computer program product comprises: a computer readable storage structure embodying computer program code thereon for execution by a computer processor with the computer program code, wherein the computer program code comprises instructions for performing the first aspect of the invention, indicated as being performed by a component or a combination of components of the mobile station or the network element.

According to a third aspect of the invention, a mobile station, comprises: a filter shaping/switching control module, responsive to a shaping filter switch signal from a network element, the shaping filter switch signal comprises characteristics of a transmitter filter needed to support an uplink signal for receiving the uplink signal by the network element from the mobile station, and configured to provide a filter instruction signal using the shaping filter switch signal; and a transmitter module, configured to provide the transmitter filter with the characteristics in response to the filter instruction signal.

Further according to the third aspect of the invention, the transmitter filter may be a finite-impulse-response digital filter and the filter instruction signal may comprise finite-impulse-response filter taps for the finite-impulse-response digital filter and the finite-impulse-response filter taps may provide the characteristics of the transmitter filter.

Still further according to the third aspect of the invention, the transmitter module may comprise a plurality of filters and the filter instruction signal may be a switching command for switching a forming uplink signal to one filter of the plurality of the filters such that the forming uplink signal is passed through the one filter without being substantially attenuated but is substantially attenuated by all other filters of the plurality of filters, wherein the one filter is the transmitter filter with the characteristics. Further, the plurality may be equal to two.

According further to the third aspect of the invention, the transmitter filter may be a digital interpolation filter and the filter instruction signal may be a cutoff frequency of the digital interpolation filter.

According still further to the third aspect of the invention, the shaping filter switch signal may be a digital bit which value indicates one of two predetermined sets of the characteristics for the transmitter filter.

According yet further still to the third aspect of the invention, the mobile station may be for wireless communications.

According further still to the third aspect of the invention, an integrated circuit may comprise the filter shaping/switching control module and the receiver module.

Still further still according to the third aspect of the invention, the uplink signal may have a dual symbol rate of 13/24 MHz with the bandwidth at half power substantially equals 541 kHz, the uplink signal may have a modified dual symbol rate of 13/32 MHz with the bandwidth at half power substantially equals 405 kHz, or the uplink signal may have a rate of 13/48 or 13/40 MHz with the bandwidth at half power substantially equals 325 kHz.

According to a fourth aspect of the invention, a mobile station, comprises: means for shaping and switching, responsive to a shaping filter switch signal from a network element, the shaping filter switch signal comprising characteristics of a transmitter filter needed to support an uplink signal for receiving the uplink signal by the network element from the mobile station, for generating and providing a filter instruction signal using the shaping filter switch signal; and means for signal generating and transmitting, for providing the transmitter filter with the characteristics in response to the filter instruction signal.

According further to the fourth aspect of the invention, the transmitter filter may be a digital filter.

According to a fifth aspect of the invention, a mobile communication system, comprises: a network element, configured to provide a shaping filter switch signal comprising characteristics of a transmitter filter needed to support receiving an uplink signal by the network element; and a mobile station, responsive to the shaping filter switch signal, configured to provide the transmitter filter with the characteristics in response to the shaping filter switch signal, for providing an uplink signal to the network element.

According further to the fifth aspect of the invention, the network element may be a base station subsystem.

According to a sixth aspect of the invention, a network element, comprises: a downlink signal generating module, configured to provide a shaping filter switch signal comprising characteristics of a transmitter filter of a mobile station needed to support receiving an uplink signal by the network element; and a transmitter, configured to transmit the shaping filter switch signal to a mobile station for providing the transmitter filter with the characteristics.

According further to the sixth aspect of the invention, the network element may be a part of an evolved global system for mobile communications/enhanced data rates for global evolution radio access network.

According to a seventh aspect of the invention, a method, comprises: generating by a network element a shaping filter switch signal comprising characteristics of a transmitter filter needed to support an uplink signal for receiving the uplink signal by the network element from a mobile station; and sending the shaping filter switch signal by the network element to the mobile station for providing the transmitter filter with the characteristics by the mobile station.

According further to the seventh aspect of the invention, the network element may be a base station subsystem for wireless communications.

### BRIEF DESCRIPTION OF THE DRAWINGS

For a better understanding of the nature and objects of the present invention, reference is made to the following detailed description taken in conjunction with the following drawings, in which:

FIG. 1 is a block diagram of a mobile communication system providing variable filtering for uplink communications, according to an embodiment of the present invention;

FIG. 2 is a schematic representation of a filter module according to one embodiment of the present invention; and

FIG. 3 is a flow chart for implementing variable filtering for uplink communications, according to an embodiment of the present invention.

### MODES FOR CARRYING OUT THE INVENTION

A new method, system, apparatus and software product are presented for variable filtering of a mobile station (MS) for supporting uplink communications using available capabilities of a network element in wireless communication systems (e.g., evolved GERAN). According to an embodiment of the present invention the MS may have at least two different pulse shaping filter capabilities (e.g., in its transmitter module) providing at least two different bandwidths: one narrower being suitable for legacy transceivers and another wider and thus optimal for variable symbol rate from performance point of view. A BSS (base station subsystem) may then request to use one of those filter capabilities according to BSS available resources. In other words, an MS transmitter filter bandwidth can be requested by a network using a downlink signal (e.g., a control signal) depending on BSS capabilities and adjacent channel protection requirements. For example, when a network employs legacy hardware, which is not able to receive wide bandwidth signals with overlapping carriers (e.g., due to increased symbol rate), the network is able to adjust the symbol rate and the transmitter filter of the MS according to the BSS uplink hardware and software capabilities.

According to an embodiment of the present invention, a network element (e.g., a base station subsystem, BSS) can sent a shaping filter switch signal comprising characteristics of a transmitter filter needed to support an uplink signal in order to be successfully received by said network element, wherein the MS can then provide the transmitter filter (e.g., a pulse shaping digital filter) with the requested characteristics by the mobile station in response to the shaping filter switch signal. Providing the transmitter filter can comprise of: generating a filter instruction signal by the MS using these characteristics, and providing this filter instruction signal to a filter module for providing this transmitter filter.

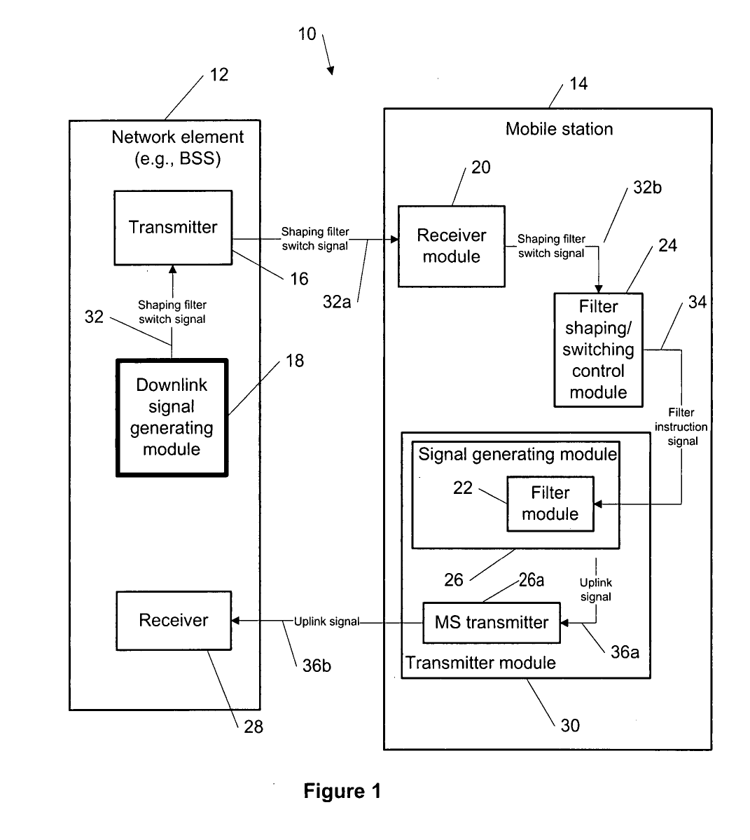

According to one embodiment, the transmitter filter can be a finite-impulse-response (FIR) digital filter and the filter instruction signal can comprise FIR filter taps for the FIR digital filter, wherein the FIR filter taps provide said characteristics of said transmitter filter. These FIR filter taps can be provided by a digital signal processor (DSP) in the MS (e.g., by filter shaping/switching control module, see FIG. 1).

According to another embodiment, the filter module can comprise a plurality of filters (e.g., at least two filters) and the filter instruction signal is a switching command for switching a forming uplink signal (e.g., a signal after modulator in a transmitter signal generating module) to one filter of this plurality such that the forming uplink signal is passed through said one filter (e.g., pulse shaping filter) without being substantially attenuated but is substantially attenuated by all other filters of said plurality of filters, wherein this one filter is the transmitter filter with the characteristics requested by the network element.

According yet to another embodiment, the transmitter filter can be a digital interpolation filter and the filter instruction signal can be, e.g., a cutoff frequency of this digital interpolation filter.

Furthermore, according to an embodiment of the present invention, the shaping filter switch signal can be a digital bit (e.g., “narrow/wide) which value indicates one of two predetermined sets of the desired characteristics for the transmitter filter. In some cases this shaping filter switch signal can comprise more than one bit (e.g., for more than two sets of the desired characteristics).

The shaping filter switch signal (bit) may be included in any downlink messages that contains “EGPRS Channel Coding” field (EGPSR stands for enhanced general packet radio service). The shaping filter switch bit can be included, e.g., within the following messages: PACKET UPLINK ACK/NACK, PACKET UPLINK ASSIGNMENT, MULTIPLE TBF UPLINK ASSIGNMENT, PACKET TIMESLOT RECONFIGURE, MULTIPLE TBF TIMESLOT RECONFIGURE or PACKET CS RELEASE INDICATION (see 3GGP TS 44.060 V7.5.0, “3GPP, Technical Specification Group GERAN, GPRS, Mobile Station (MS)—Base Station System (BSS) Interface, Radio Link/Medium Access Control (RLC/MAC) Protocol”, Section 11.2).

It is further noted that the transmitter filter, described herein, can support uplink signals which can have various symbol rates including (but not limited to) rates different than in the enhanced general packet radio service (EGPRS) having, e.g., symbol rate of 13/48 MHz (with the bandwidth at half power substantially equals 180 kHz) such as a dual symbol rate of 13/24 MHz with the bandwidth at half power substantially equals 541 kHz, a modified dual symbol rate of 13/32 MHz with the bandwidth at half power substantially equals 405 kHz, a symbol rate of 13/48 or 13/40 MHz with the bandwidth at half power substantially equals 325 kHz for a Higher Uplink performance for GERAN Evolution (HUGE), etc.

FIG. 1 shows an example among others of a block diagram of a mobile communication system 10 providing variable filtering for uplink communications, according to an embodiment of the present invention.

In the example of FIG. 1, the mobile station 14 can comprise a receiver module 20, a filter shaping/switching control module 24 and a transmitter module 30 which comprises a signal generating module 26 and an MS transmitter (e.g., an antenna) 26a. The module 26 typically comprises a filter module 22 with the transmitter filter having desired characteristics or configurable to have these characteristics, requested by a network element 12 (e.g., BSS). The module 24 can be generally viewed as means for shaping and switching or a structural equivalence (or an equivalent structure) thereof. Also, the module 30 can generally be means for signal generating and transmitting or a structural equivalence (or equivalent structure) thereof. In the context of the present invention, the mobile station 14 can be a wireless communication device, a portable device, a mobile communication device, a mobile phone, a mobile camera phone, etc.

The module 26 can typically comprise, among other possibilities, a source of bits (the information bits to be transmitted), channel coding means (e.g., providing turbo coding or convolution coding); interleaving means for reordering of bits, modulation means for modulating a signal, e.g., using 8 PSK, 16-QAM etc., a pulse shaping filter which is shown as the filter module 22 for filtering the transmitted symbols and creating the desired frequency characteristics of the signal, a digital-to-analog converter and other standard components (amplifier, frequency converter, etc.) for providing a feeding signal, shown as an uplink signal 36a to the antenna. The signal 36a is sent as a signal 36b to a receiver 28 of the network element 12.

Furthermore, the network element 12 can comprise a downlink signal generating module 18 and a transmitter 16.

According to an embodiment of the present invention, the module 22, 24, 26 or 18 can be implemented as a software or a hardware block or a combination thereof. Furthermore, the module 22, 24, 26 or 18 can be implemented as a separate block or can be combined with any other standard block or module of the user equipment 14 or of the network element 12, or it can be split into several blocks according to their functionality.

All or selected modules of the user equipment 14 can be implemented using an integrated circuit, and all or selected blocks and/or modules of the network element 12 can be implemented using an integrated circuit as well.

A downlink (DL) shaping filter switch signal 32 (e.g., generated by the module 18) is transmitted by the transmitter block 18 of the network element 12 to the receiver module 20 of the mobile station 14 (see signal 32a) and then forwarded (signal 32b) to the module 24 which generates and provides a filter instruction signal 34, according to embodiments of the present invention described in detail herein, to the filter module 22 which provides the transmitter filter with the desired characteristics as requested by the network in order to support successful receiving the uplink signal 36b by said network element from said mobile station;

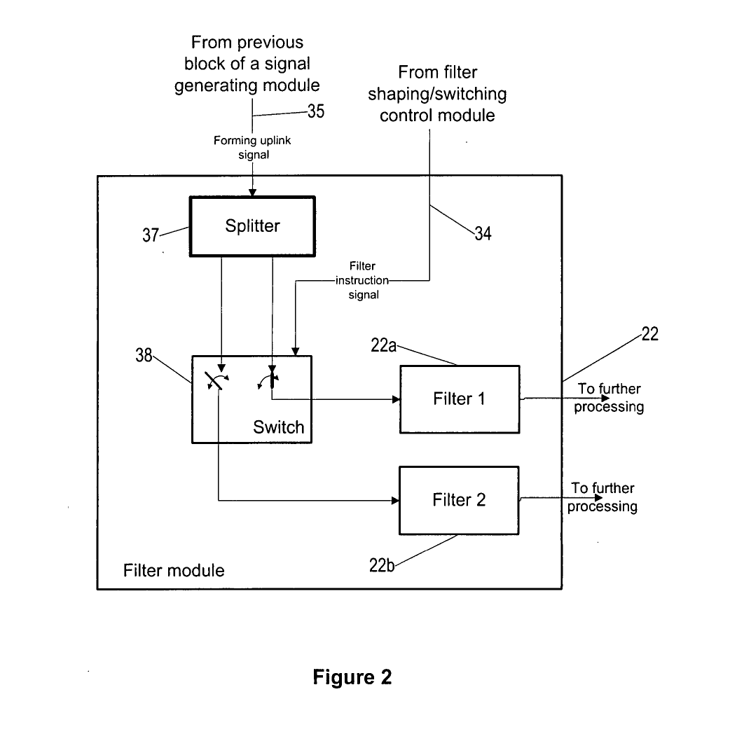

FIG. 2 is a schematic representation of a filter module 22 according to one embodiment of the present invention. Here, there are two “fixed” filters 22a and 22b which can provide output signals with two sets of desired characteristics (e.g., one for a legacy receiver and another for a higher bandwidth advanced receiver at the network element) in order to support receiving the uplink signal by the network. The filter instruction signal 34 is provided to a switch 38 which switches a forming uplink signal 35 (the signal 35 is divided into two identical signals by a splitter 37 as shown) from a previous processing module ( e.g., a modulator) between the filters 22a and 22b according to the filter instruction signal 34 (to support the characteristics requested by the network element).

It is noted that other switching arrangement can be used (e.g., using two switches for each filter 22a and 22b instead of the switch 38). Also, it could be more than two “fixed” filters: e.g., one for the legacy receivers and two or more for advanced receivers with higher but different bandwidths.

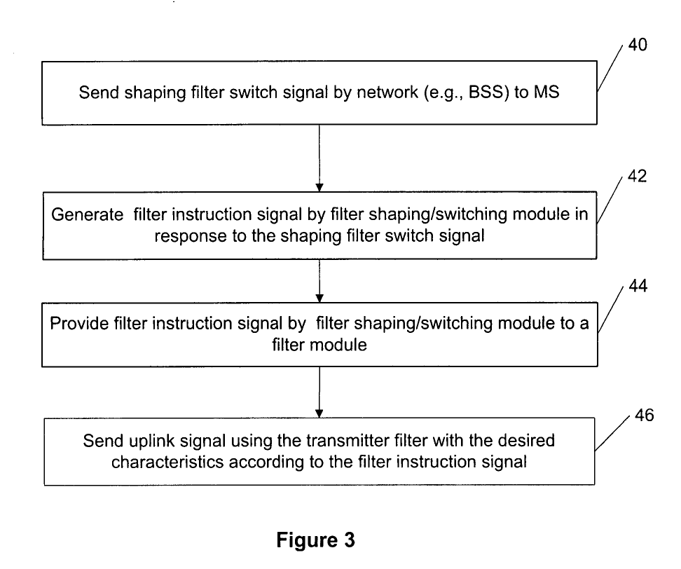

FIG. 3 is an example of a flow chart for implementing variable filtering for uplink communications, according to an embodiment of the present invention.

The flow chart of FIG. 3 only represents one possible scenario among others. The order of steps shown in FIG. 3 is not absolutely required, so generally, the various steps can be performed out of order. In a method according to an embodiment of the present invention, in a first step 40, the network element 12 (e.g., BSS) sends the shaping filter switch signal 32 to the mobile station 14 (received as the signal 32b and forwarded to the module 24 as the signal 32b).

In a next step 42, the filter shaping/switching control module 24 generates the filter instruction signal 34 in response to the shaping filter switch signal 32b, according to various embodiments described herein. In a next step 44, this filter instruction signal 34 is provided to the filter module 22. Finally, in a step 46, the uplink signal with the desired characteristics according to the filter instruction signal 34 is generated (signal 36a) and sent (signal 36b) by the transmitter module 30 of the mobile station 14 to the network element 12.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

It is noted that various embodiments of the present invention recited herein can be used separately, combined or selectively combined for specific applications.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
receiving by a mobile station from a network element a shaping filter switch signal comprising characteristics of a transmitter filter needed to support an uplink signal for receiving said uplink signal by said network element from said mobile station;
providing said transmitter filter with said characteristics by said mobile station in response to said shaping filter switch signal.

2. The method of claim 1, wherein said providing said transmitter filter comprises:
generating a filter instruction signal by said mobile station using said characteristics; and
providing said filter instruction signal to a filter module for providing said transmitter filter.

3. The method of claim 2, wherein said transmitter filter is a finite-impulse-response digital filter and said filter instruction signal comprises finite-impulse-response filter taps for said finite-impulse-response digital filter and said finite-impulse-response filter taps provide said characteristics of said transmitter filter.

4. The method of claim 2, wherein said filter module comprises a plurality of filters and said filter instruction signal is a switching command for switching a forming uplink signal to one filter of said plurality of said filters such that said forming uplink signal is passed through said one filter without being substantially attenuated but is substantially attenuated by all other filters of said plurality of filters, wherein said one filter is said transmitter filter with said characteristics.

5. The method of claim 4, wherein said plurality is equal to two.

6. The method of claim 2, wherein said transmitter filter is a digital interpolation filter and said filter instruction signal is a cutoff frequency of said digital interpolation filter.

7. The method of claim 1, wherein said shaping filter switch signal is a digital bit which value indicates one of two predetermined sets of said characteristics for said transmitter filter.

8. The method of claim 1, wherein said transmitter filter is a digital filter.

9. The method of claim 1, wherein said uplink signal has a dual symbol rate of 13/24 MHz with said bandwidth at half power substantially equals 541 kHz, said uplink signal has a modified dual symbol rate of 13/32 MHz with said bandwidth at half power substantially equals 405 kHz, or said uplink signal has a rate of 13/48 or 13/40 MHz with said bandwidth at half power substantially equals 325 kHz.

10. A computer program product comprising: a computer readable storage structure embodying computer program code thereon for execution by a computer processor with said computer program code, wherein said computer program code comprises instructions for performing the method of claim 1, indicated as being performed by a component or a combination of components of said mobile station or said network element.

11. A method, comprising:
generating by a network element a shaping filter switch signal comprising characteristics of a transmitter filter needed to support an uplink signal for receiving said uplink signal by said network element from a mobile station; and
sending said shaping filter switch signal by the network element to the mobile station for providing said transmitter filter with said characteristics by said mobile station.

12. The method of claim 11, wherein said network element is a base station subsystem for wireless communications.

13. A computer program product comprising: a computer readable storage structure embodying computer program code thereon for execution by a computer processor with said computer program code, wherein said computer program code comprises instructions for performing the method of claim 11, indicated as being performed by a component or a combination of components of said mobile station or said network element.

14. A mobile station, comprising:
a filter shaping/switching control module, responsive to a shaping filter switch signal from a network element, said shaping filter switch signal comprising characteristics of a transmitter filter needed to support an uplink signal for receiving said uplink signal by said network element from said mobile station, configured to generate and providing a filter instruction signal using said shaping filter switch signal; and
a transmitter module, configured to provide said transmitter filter with said characteristics in response to said filter instruction signal.

15. The mobile station of claim 14, wherein said transmitter filter is a finite-impulse-response digital filter and said filter instruction signal comprises finite-impulse-response filter taps for said finite-impulse-response digital filter and said finite-impulse-response filter taps provide said characteristics of said transmitter filter.

16. The mobile station of claim 14, wherein said transmitter module comprises a plurality of filters and said filter instruction signal is a switching command for switching a forming uplink signal to one filter of said plurality of said filters such that said forming uplink signal is passed through said one filter without being substantially attenuated but is substantially attenuated by all other filters of said plurality of filters, wherein said one filter is said transmitter filter with said characteristics.

17. The mobile station of claim 16, wherein said plurality is equal to two.

18. The mobile station of claim 14, wherein said transmitter filter is a digital interpolation filter and said filter instruction signal is a cutoff frequency of said digital interpolation filter.

19. The mobile station of claim 14, wherein said shaping filter switch signal is a digital bit which value indicates one of two predetermined sets of said characteristics for said transmitter filter.

20. The mobile station of claim 14, wherein said mobile station is for wireless communications.

21. The mobile station of claim 14, wherein an integrated circuit comprises the filter shaping/switching control module and the receiver module.

22. The mobile station of claim 14, wherein said uplink signal has a dual symbol rate of 13/24 MHz with said bandwidth at half power substantially equals 541 kHz, said uplink signal has a modified dual symbol rate of 13/32 MHz with said bandwidth at half power substantially equals 405 kHz, or said uplink signal has a rate of 13/48 or 13/40 MHz with said bandwidth at half power substantially equals 325 kHz.

23. A mobile station, comprising:
means for shaping and switching, responsive to a shaping filter switch signal from a network element, said shaping filter switch signal comprising characteristics of a transmitter filter needed to support an uplink signal for receiving said uplink signal by said network element from said mobile station, for generating and providing a filter instruction signal using said shaping filter switch signal; and
means for signal generating and transmitting, for providing said transmitter filter with said characteristics in response to said filter instruction signal.

24. The mobile station of claim 23, wherein said transmitter filter is a digital filter.

25. A mobile communication system, comprising:
a network element, configured to provide a shaping filter switch signal comprising characteristics of a transmitter filter needed to support receiving an uplink signal by said network element; and
a mobile station, responsive to said shaping filter switch signal, configured to provide said transmitter filter with said characteristics in response to said shaping filter switch signal, for providing an uplink signal to said network element.

26. A mobile communication system of claim 26, wherein said network element is a base station subsystem.

27. A network element, comprising:
a downlink signal generating module, configured to provide a shaping filter switch signal comprising characteristics of a transmitter filter of a mobile station needed to support receiving an uplink signal by said network element; and
a transmitter, configured to transmit said shaping filter switch signal to a mobile station for providing said transmitter filter with said characteristics.

28. A network element of claim 27, wherein said network element is a part of an evolved global system for mobile communications/ enhanced data rates for global evolution radio access network.
